(19) United States
(12) Patent Application Publication
(10) Pub. No.: US 2022/0402062 A1
(43) Pub. Date: Dec. 22, 2022

(54) SYSTEMS AND METHODS PROVIDING COORDINATED DUAL POWER OUTPUTS SUPPORTING A SAME WELDING OR AUXILIARY POWER PROCESS

(71) Applicant: Lincoln Global, Inc., Santa Fe Springs, CA (US)

(72) Inventor: Edward A. Enyedy, Eastlake, OH (US)

(21) Appl. No.: 17/893,386

(22) Filed: Aug. 23, 2022

Related U.S. Application Data
(63) Continuation of application No. 16/553,306, filed on Aug. 28, 2019.

(51) Int. Cl. B23K 9/095; B23K 9/10; B23K 9/12; B23K 9/167; B23K 9/173; B23K 9/09; B23K 9/32; B23K 9/16

(52) U.S. Cl. CPC B23K 9/0953; B23K 9/1075; B23K 9/1093; B23K 9/124; B23K 9/1062; B23K 9/167; B23K 9/173; B23K 9/091; B23K 9/32; B23K 9/164

(57) ABSTRACT

Embodiments of welding systems and methods with coordinated dual power outputs supporting a same welding process or a same AC output process are disclosed. One embodiment of a welding system includes an engine and a generator operatively connected to the engine, where the engine is configured to drive the generator to produce electrical input power. The welding system also includes a power supply operatively connected to the generator and having at least one controller. The power supply is configured to convert the electrical input power to form two power outputs that are coordinated with each other, at least in time, via the controller to support a same welding process. The same welding process may be, for example, a hotwire welding process, a tandem metal inert gas (MIG) welding process, or an alternating current (AC) output process.

### CROSS REFERENCE TO RELATED APPLICATION/INCORPORATION BY REFERENCE

This U.S. Patent Application is a continuation of U.S. patent application Ser. No. 16/553,306 filed on Aug. 28, 2019, which is incorporated herein by reference in its entirety.

The disclosure of U.S. Pat. No. 10,279,414, issued on May 7, 2019, is incorporated herein by reference in its entirety, and is concerned with engine driven welding technology. The disclosure of U.S. Pat. No. 9,114,483, issued on Aug. 25, 2015, is incorporated herein by reference in its entirety, and is concerned with wire feeding technology. The disclosure of U.S. Pat. No. 9,751,150, issued on Sep. 5, 2017, is incorporated herein by reference in its entirety, and is concerned with power electronics technology in power sources. The disclosure of U.S. Pat. No. 8,785,816 entitled “Three Stage Power Source for Electric Arc Welding,” issued on Jul. 22, 2014, is incorporated herein by reference in its entirety, and is concerned with power and control electronics. The disclosure of U.S. Pat. No. 9,409,250, issued on Aug. 9, 2016, is incorporated herein by reference in its entirety, and is concerned with hotwire welding technology.

### FIELD

Embodiments of the present invention relate to welding machines and methods, and more specifically to welding machines (e.g., engine-driven welding machines) and methods providing coordinated dual power outputs supporting a same welding or auxiliary power process.

### BACKGROUND

While many welding machines (e.g., engine-driven machines) are configured with one set of controls, some machines have two sets of controls (a dual machine). This allows for two operators to, for example, weld simultaneously and independently. For example, one operator may perform a stick welding process while another operator performs a flux-cored arc welding (FCAW) process. Noise is reduced because only one engine is running instead of two. Only one engine requires servicing rather than two (e.g. for oil changes, etc.).

### SUMMARY

Embodiments of the present invention build upon the platforms for dual process welding machines (e.g., engine-driven machines) such that both sides are controlled by a single operator, yet are providing two coordinated power outputs that support a same process.

In one embodiment, a hotwire welding system is provided. The hotwire welding system includes an engine and a generator operatively connected to the engine, where the engine is configured to drive the generator to produce electrical power. The hotwire welding system also includes a power supply operatively connected to the generator and having at least one controller. The power supply is configured to convert the electrical power to form two power outputs that are coordinated with each other, at least in time, via the at least one controller to support a same hotwire welding process. A first power output of the two power outputs is an arc welding output and a second power output of the two power outputs is a filler wire heating output. The hotwire welding system also includes a wire feeding device operatively connected to the power supply and configured to feed a filler wire toward a workpiece during the same hotwire welding process. In one embodiment, the arc welding output may be one of a tungsten inert gas (TIG) welding output, a metal inert gas (MIG) welding output, a submerged arc welding (SAW) output, or a flux cored arc welding (FCAW) output. The power supply includes a first output terminal, a second output terminal, a third output terminal, and a fourth output terminal. In one embodiment, the first output terminal is associated with the first power output, has a first polarity, and is to be electrically connected to a workpiece during the same hotwire welding process. The second output terminal is associated with the second power output, has the first polarity, and is to be electrically connected to the workpiece during the same hotwire welding process. The third output terminal is associated with the first power output, has a second polarity, and is to be electrically connected to a welding electrode during the same hotwire welding process. The fourth output terminal is associated with the second power output, has the second polarity, and is to be electrically connected to the filler wire via the wire feeding device during the same hotwire welding process. In some embodiments, the at least one controller includes a first controller configured to control the first power output and a second controller configured to control the second power output. For example, in one embodiment, the first controller is configured to communicate with the second controller to communicate information about at least one of triggering the two power outputs on and off, gas flow, and filler wire heating power. In one embodiment, the second controller is configured to receive communications from the first controller, and the second controller is configured to adjust the second power output and a wire feed speed of the wire feeding device in response to communications received from the first controller. In one embodiment, the second controller is configured to receive communications from the first controller indicating that the first controller is commanding pulsing of the first power output. The second controller is configured to command pulsing of a wire feed speed of the wire feeding device in coordination with the pulsing of the first power output in response to the communications. In one embodiment, the second controller is configured to receive communications from the first controller indicating that the first controller is commanding pulsing of the first power output. The second controller is configured to command pulsing of the second output power in coordination with the pulsing of the first power output in response to the communications.

In one embodiment, a tandem metal inert gas (MIG) welding system is provided. The tandem metal inert gas (MIG) welding system includes an engine and a generator operatively connected to the engine, where the engine is configured to drive the generator to produce electrical power. The tandem metal inert gas (MIG) welding system also includes a power supply operatively connected to the generator and having at least one controller. The power supply is configured to convert the electrical power to form two power outputs that are coordinated with each other, at least in time, via the at least one controller to support a same tandem metal inert gas (MIG) welding process. A first power output of the two power outputs is a first metal inert gas (MIG) welding output and a second power output of the two power outputs is a second metal inert gas (MIG) welding output. In one embodiment, the tandem metal inert gas (MIG) welding system includes an orbital welding bug including a first metal deposition welding device and a second metal deposition welding device. The first metal deposition welding device is powered by the first metal inert gas (MIG) welding output and the second metal deposition welding device is powered by the second metal inert gas (MIG) welding output. The orbital welding bug is configured to orbit around a joint between two sections of a workpiece to be welded together. In one embodiment, the power supply is configured to pulse the first metal inert gas (MIG) welding output to create a first pulsing arc via the first metal deposition welding device. The power supply is configured to pulse the second metal inert gas (MIG) welding output to create a second pulsing arc via the second metal deposition welding device. The power supply is configured to synchronize the first pulsing arc and the second pulsing arc in time. The power supply includes a first output terminal, a second output terminal, a third output terminal, and a fourth output terminal. In one embodiment, the first output terminal is associated with the first power output, has a first polarity, and is to be electrically connected to the first metal deposition welding device during the same tandem metal inert gas (MIG) welding process. The second output terminal is associated with the first power output, has a second polarity, and is to be electrically connected to the workpiece during the same tandem metal inert gas (MIG) welding process. The third output terminal is associated with the second power output, has the first polarity, and is to be electrically connected to the second metal deposition welding device during the same tandem metal inert gas (MIG) welding process. The fourth output terminal is associated with the second power output, has the second polarity, and is to be electrically connected to the workpiece during the same tandem metal inert gas (MIG) welding process. In one embodiment, the first metal deposition welding device includes a first welding head and a first wire electrode delivery mechanism. The second metal deposition welding device includes a second welding head and a second wire electrode delivery mechanism. In one embodiment, the at least one controller includes a first controller configured to control the first power output and a second controller configured to control the second power output. The first controller is configured to communicate with the second controller to communicate information about at least pulsing the two power outputs in a coordinated manner.

In one embodiment, an alternating current (AC) output system is provided. The alternating current (AC) output system includes an engine and a generator operatively connected to the engine, where the engine is configured to drive the generator to produce electrical power. The alternating current (AC) output system also includes a power supply operatively connected to the generator and having at least one controller. The power supply is configured to convert the electrical power to form two power outputs that are coordinated with each other, at least in time, via the at least one controller to support a same alternating current (AC) output process. A first power output of the two power outputs provides a positive current portion and a second power output of the two power outputs provides a negative current portion. In one embodiment, the positive current portion and the negative current portion, as coordinated, provide an alternating current for creating a welding arc between a welding electrode and a workpiece. In one embodiment, the positive current portion and the negative current portion, as coordinated, provide a sinusoidal alternating current for powering an auxiliary tool. The power supply includes a first output terminal, a second output terminal, a third output terminal, and a fourth output terminal. In one embodiment, the first output terminal is associated with the first power output, has a first polarity, and is to be electrically connected to a welding electrode during the same alternating current (AC) output process. The second output terminal is associated with the second power output, has the first polarity, and is to be electrically connected to a workpiece during the same alternating current (AC) output process. The third output terminal is associated with the first power output, has a second polarity, and is to be electrically connected to the second output terminal during the same alternating current (AC) output process. The fourth output terminal is associated with the second power output, has the second polarity, and is to be electrically connected to the first output terminal during the same alternating current (AC) output process. In one embodiment, the first output terminal is associated with the first power output, has a first polarity, and is to be electrically connected to an auxiliary tool during the same alternating current (AC) output process. The second output terminal is associated with the first power output, has a second polarity, and is to be electrically connected to the auxiliary tool during the same alternating current (AC) output process. The third output terminal is associated with the second power output, has the first polarity, and is to be electrically connected to the second output terminal during the same alternating current (AC) output process. The fourth output terminal is associated with the second power output, has the second polarity, and is to be electrically connected to the first output terminal during the same alternating current (AC) output process. In one embodiment, the alternating current (AC) output system also includes a wire feeding device operatively connected to the power supply. In one embodiment, the at least one controller includes a first controller configured to control the first power output and a second controller configured to control the second power output, and where the first controller is configured to communicate with the second controller to communicate coordinating information.

Numerous aspects of the general inventive concepts will become readily apparent from the following detailed description of exemplary embodiments and from the accompanying drawings.

### BRIEF DESCRIPTION OF THE DRAWINGS

The accompanying drawings, which are incorporated in and constitute a part of the specification, illustrate various embodiments of the disclosure. It will be appreciated that the illustrated element boundaries (e.g., boxes, groups of boxes, or other shapes) in the figures represent one embodiment of boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a block diagram of one embodiment of a system providing coordinated dual power outputs supporting a same welding or auxiliary power process;

FIG. 2 illustrates a flow chart of one embodiment of a method performed by the system of FIG. 1,

FIG. 3 illustrates a schematic diagram of one embodiment of a hotwire welding system including a power supply (e.g., similar to the power supply of FIG. 1) configured to provide two power outputs that are coordinated with each other to support a same hotwire welding process;

FIG. 4 illustrates a schematic diagram of one embodiment of a tandem metal inert gas (MIG) welding system including a power supply (e.g., similar to the power supply of FIG. 1) configured to provide two power outputs that are coordinated with each other to support a same tandem metal inert gas (MIG) welding process;

FIG. 5 illustrates a schematic diagram of one embodiment of an alternating current (AC) output system including a power supply (e.g., similar to the power supply of FIG. 1) configured to provide two power outputs that are coordinated with each other to support a same AC welding process;

FIG. 6 illustrates a schematic diagram of one embodiment of an alternating current (AC) output system including a power supply (e.g., similar to the power supply of FIG. 1) configured to provide two power outputs that are coordinated with each other to provide a sinusoidal alternating current for powering an auxiliary tool; and

FIG. 7 illustrates one embodiment of an example controller used in the power supply of the system of FIG. 1.

### DETAILED DESCRIPTION

Embodiments of the present invention are concerned with providing coordinated dual power outputs supporting a same welding or auxiliary power process. In this manner, instead of having specialized equipment for less common processes, embodiments of a coordinated dual power output machine provide common welding or auxiliary processes as well as processes that require more than one DC supply.

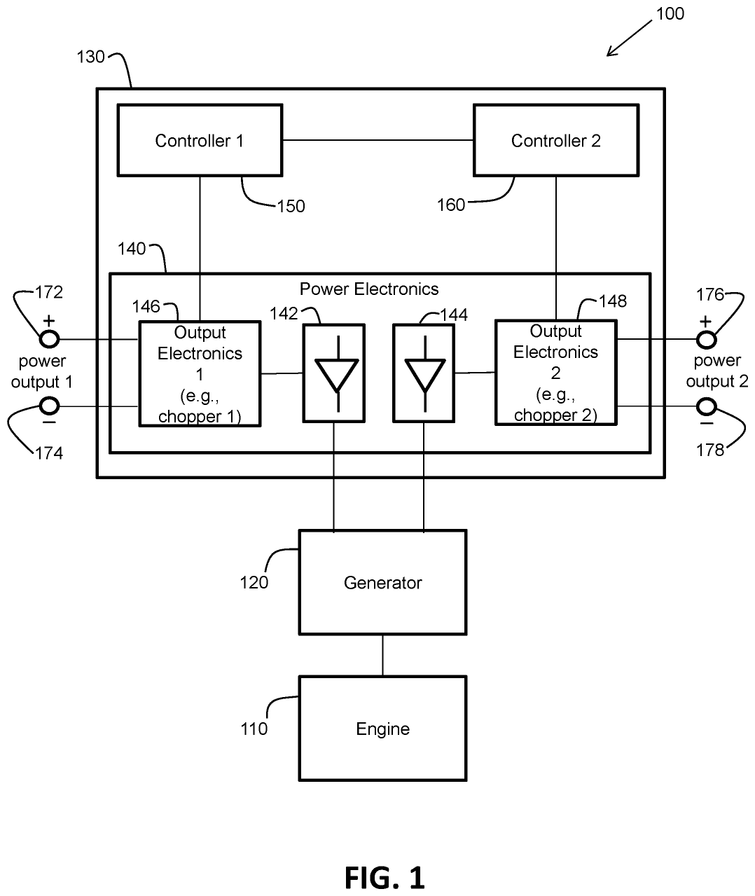

The examples and figures herein are illustrative only and are not meant to limit the subject invention, which is measured by the scope and spirit of the claims. FIG. 1 illustrates a block diagram of one embodiment of a system 100 providing coordinated dual power outputs supporting a same welding or auxiliary power process. The system 100 includes an engine 110 (e.g., a diesel or gasoline engine) and a generator 120. The generator 120 is operatively connected to the engine 110, where the engine is configured to drive the generator to produce electrical input power. The generator 120 may include, for example, an alternator (not shown), a voltage regulator (not shown), and a main controller (not shown), in accordance with one embodiment. The disclosure of U.S. Pat. No. 10,279,414, issued on May 7, 2019, is incorporated herein by reference in its entirety, and is concerned with engine-driven welding technology. Therefore, engine-driven welding technology will not be further elaborated upon herein. The system 100 also includes a power supply 130 configured to convert the electrical input power from the generator 120 to form two power outputs that are coordinated with each other. However, in accordance with certain alternative embodiments, the engine 110 and the generator 120 may not be present. Instead, the power supply 130 receives the electrical input power from the local electrical power grid.

Regardless, the power supply 130 includes power electronics 140 that includes first rectifier circuitry 142, second rectifier circuitry 144, first output electronics 146 (output electronics 1), and second output electronics 148 (output electronics 2). For example, in one embodiment, the first output electronics 146 is a first chopper circuit (chopper 1) and the second output electronics 148 is a second chopper circuit (chopper 2). Other types of output electronics are possible as well, in accordance with other embodiments. In one embodiment, the power electronics 140 can be viewed as providing two direct current (DC) supplies, which are coordinated with each other, in a single power supply.

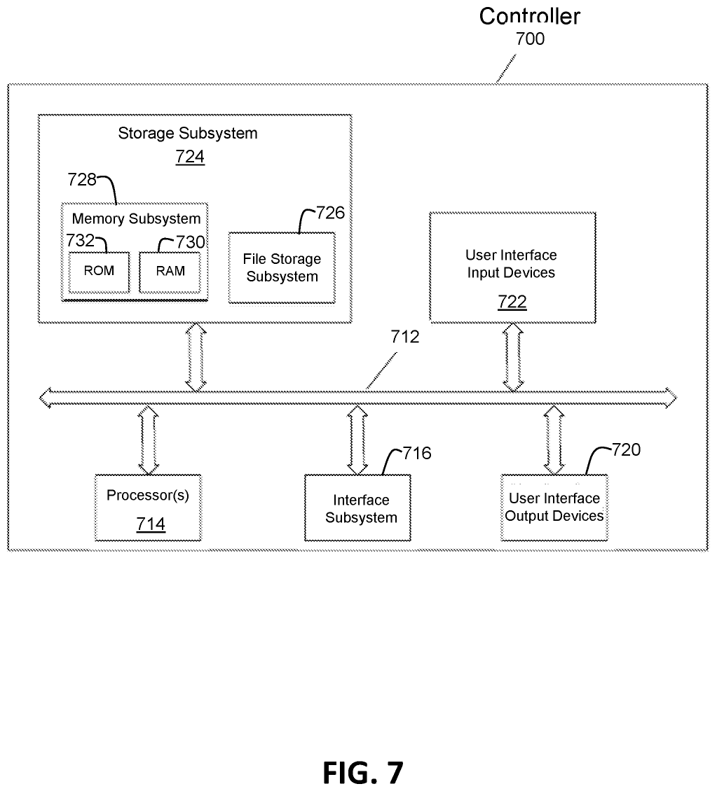

The power supply 130 also includes a first controller (control circuitry) 150 (controller 1) and a second controller (control circuitry) 160 (controller 2). The first controller 150 is configured to control at least the first output electronics 146, and the second controller 160 is configured to control at least the second output electronics 148. In accordance with one embodiment, the controllers 150 and 160 are also configured to communicate with each other (e.g., via digital communication techniques), for purposes discussed later herein. In an alternative embodiment, the controllers 150 and 160 may be configured as a single controller that performs the functions of the controllers 150 and 160. The controllers and the power electronics may include various types of circuitry including, for example, at least one of a microprocessor, an application specific integrated circuit (ASIC), a field programmable gate array (FPGA), a digital signal processor, a programmable logic device (PLD), and a memory. The disclosure of U.S. Pat. No. 9,751,150, issued on Sep. 5, 2017, is incorporated herein by reference in its entirety, and is concerned with power electronics technology in power sources. The disclosure of U.S. Pat. No. 8,785,816 entitled “Three Stage Power Source for Electric Arc Welding,” issued on Jul. 22, 2014, is incorporated herein by reference in its entirety, and is concerned with power and control electronics. Therefore, power electronics technology will not be further elaborated upon herein. However, controller technology is discussed further herein with respect to FIG. 7.

Referring to FIG. 1, the first rectifier circuitry 142 and first output electronics 146 are configured to provide a first power output (power output 1) via output terminals 172 and 174. The output terminal 172 is a positive polarity output terminal and the output terminal 174 is a negative polarity output terminal. Similarly, the second rectifier circuitry 144 and second output electronics 148 are configured to provide a second power output (power output 2) via output terminals 176 and 178. The output terminal 176 is a positive polarity output terminal and the output terminal 178 is a negative polarity output terminal. Again, the first controller 150 is configured to control at least the first output electronics 146 to generate the first power output (power output 1). The second controller 160 is configured to control at least the second output electronics 148 to generate the second power output (power output 2). The power outputs may be of various types (e.g. a welding power output, a hotwire heating output, or an auxiliary power output) as discussed later herein. The power outputs may have various waveform characteristics such as, for example, direct current (DC) characteristics, alternating current (AC) characteristics (e.g., sinusoidal or square wave), pulsed characteristics, or other waveform characteristics, in accordance with various embodiments.

In accordance with one embodiment, the first power output and the second power output are coordinated at least in time or phase via the first controller 150 and the second controller 160. The first power output and the second power output may also be coordinated in amplitude (e.g., current amplitude and/or voltage amplitude) and/or frequency, in accordance with other embodiments. For example, in one embodiment, the first controller 150 sends coordinating information (e.g., timing or phase information, amplitude information, frequency information) to the second controller 160. The second controller 160 uses the coordinating information to ensure that the second power output is coordinated with the first power output. As a result, the first controller 150 acts as a master controller and the second controller 160 acts as a slave controller. Other coordinating configurations are possible as well, in accordance with other embodiments.

As one example, the first power output may be an arc welding output and the second power output may be a filler wire heating output. The arc welding output and the filler wire heating output are coordinated with each other, as discussed later herein, to support a same hotwire welding process. As another example, the first power output may be a first MIG welding output and the second power output may be a second MIG welding output. The two MIG welding outputs are coordinated with each other, as discussed later herein, to support a same tandem MIG welding process. As still a further example, the first power output may provide a positive current portion and the second power output may provide a negative current portion. The positive current portion and the negative current portion are coordinated with each other, as discussed later herein, to support a same alternating current (AC) output process (e.g., an AC welding process or an auxiliary tool process).

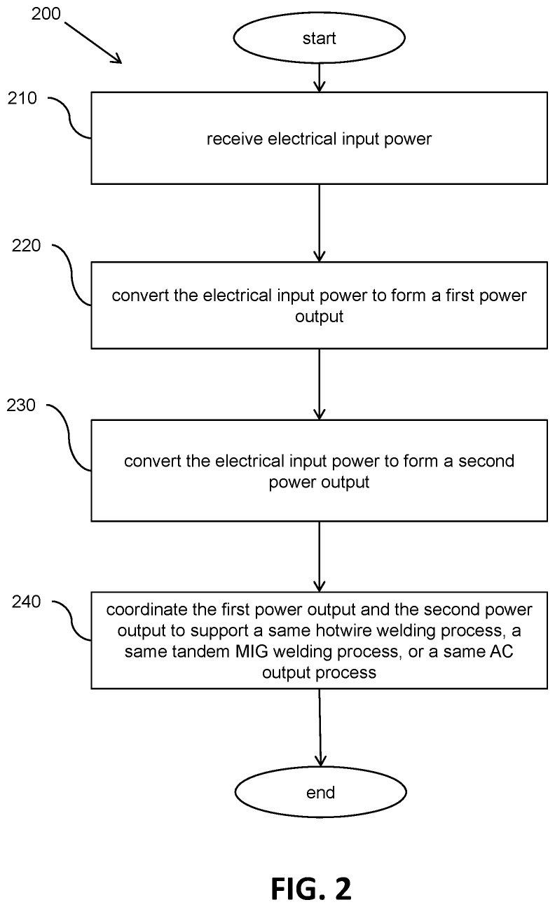

FIG. 2 illustrates a flow chart of one embodiment of a method 200 performed by the system 100 of FIG. 1. At block 210, electrical input power (e.g., 3-phase electrical input power) is received (e.g., by the power supply 130 from the generator 120 as driven by the engine 110). At block 620, the electrical input power is converted (e.g., by the first rectifier circuitry 142 and the first output electronics 146 of the power supply 130) to form a first power output (e.g. at the output terminals 172 and 174). At block 630, the electrical input power is converted (e.g., by the second rectifier circuitry 144 and the second output electronics 148 of the power supply 130) to form a second power output (e.g., at the output terminals 176 and 178). At block 640, the first power output and the second power output are coordinated (e.g., at least in time via the controllers 150 and 160 of the power supply 130) to support a same hotwire welding process, a same tandem MIG welding process, or a same AC output process. That is, the two power outputs are supporting a same process, for example, for a single human operator. To be clear, a “same process”, as used herein, does not refer to, for example, two processes of the same type. Instead, the two power outputs are coordinated to support a same single process (e.g., a single hotwire welding process, a single AC welding process, or a single tandem MIG welding process).

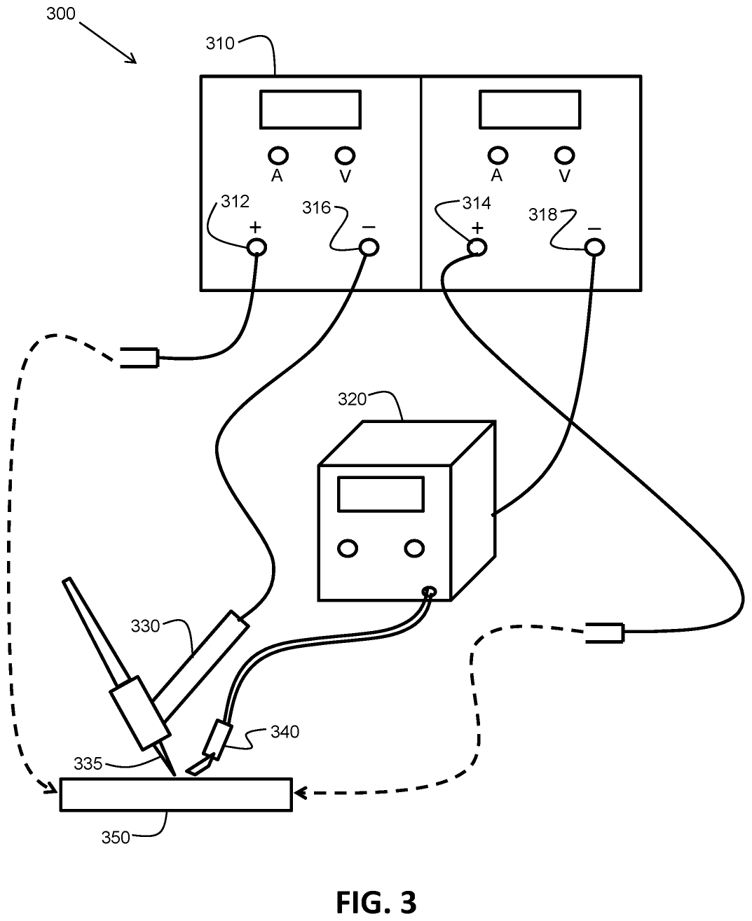

FIG. 3 illustrates a schematic diagram of one embodiment of a hotwire welding system 300 including a power supply 310 (e.g., similar to the power supply 130 of FIG. 1) configured to provide two power outputs that are coordinated with each other to support a same hotwire welding process. The power supply 310 includes at least one controller as in FIG. 1 (e.g., the controllers 150 and 160). The hotwire welding system 300 may also include an engine 110 and a generator 120 as in FIG. 1, in accordance with one embodiment, where the power supply 310 is configured to receive electrical input power from the generator. Alternatively, the power supply 310 may be configured to receive electrical input power from the local electrical power grid. The hotwire welding system 300 also includes a wire feeding device 320, a welding torch 330 (e.g., a TIG or MIG welding torch), and a filler wire contact tube 340.

The power supply 310 is configured to convert the electrical input power (whether from a generator or a local electrical power grid) to form two power outputs that are coordinated with each other (e.g., coordinated in time, phase, frequency, and/or amplitude) via at least one controller to support a same hotwire welding process. The first power output of the two power outputs is an arc welding output and the second power output of the two power outputs is a filler wire heating output. The wire feeding device 320 is operatively connected to the power supply 310 and configured to feed a filler wire toward a workpiece 350 during the same hotwire welding process. Wire feeding devices are well known to those of ordinary skill in the art and need not be described in detail herein. However, as an example, the disclosure of U.S. Pat. No. 9,114,483, issued on Aug. 25, 2015, is incorporated herein by reference in its entirety, and is concerned with wire feeding technology. The arc welding output may be one of a tungsten inert gas (TIG) welding output, a metal inert gas (MIG) welding output, a submerged arc welding (SAW) output, or a flux cored arc welding (FCAW) output, in accordance with various embodiments. The disclosure of U.S. Pat. No. 9,409,250, issued on Aug. 9, 2016, is incorporated herein by reference in its entirety, and is concerned with hotwire welding technology.

As shown in FIG. 3, a first output terminal 312 of the power supply 310 is associated with the first power output, has a first polarity (e.g., a positive [+] polarity), and is electrically connected to the workpiece 350 during the same hotwire welding process. A second output terminal 314 of the power supply 310 is associated with the second power output, has the first polarity (e.g., a positive [+] polarity), and is electrically connected to the workpiece 350 during the same hotwire welding process. A third output terminal 316 of the power supply 310 is associated with the first power output, has a second polarity (e.g., a negative [−] polarity), and is electrically connected to a welding electrode 335 via the welding torch 330 during the same hotwire welding process. A fourth output terminal 318 of the power supply 310 is associated with the second power output, has the second polarity (e.g., a negative [−] polarity), and is electrically connected to the filler wire via the contact tube 340 and the wire feeding device 320 during the same hotwire welding process. The electrical connections are facilitated by various electrical cables and clamps, as shown in FIG. 3.

In accordance with one embodiment, the power supply 310 includes a first controller (e.g., the controller 150 shown in FIG. 1) that is configured to control the first power output (i.e., the arc welding output) and a second controller (e.g., the controller 160 shown in FIG. 1) that is configured to control the second power output (i.e., the filler wire heating output). The first controller is configured to communicate with the second controller to communicate coordinating information about, for example, triggering the two power outputs on and off, controlling gas flow, and/or controlling heating power for the filler wire during a same hotwire welding process. In one embodiment, the second controller is configured to receive communications from the first controller and adjust the second power output and a wire feed speed of the wire feeding device in response to the received communications during a same hotwire welding process.

For example, the second controller is configured to receive communications from the first controller indicating that the first controller is commanding pulsing of the first power output during a same hotwire welding process. The second controller is configured to command pulsing of a wire feed speed of the wire feeding device in coordination with the pulsing of the first power output in response to the communications during the same hotwire welding process. Also, the second controller is configured to command pulsing of the second power output in coordination with the pulsing of the first power output in response to the communications during the same hotwire welding process. Furthermore, rates of shielding gas may be controlled in a coordinated manner during a same hotwire welding process based on communications between the first controller and the second controller.

In this manner, the hotwire welding system 300 of FIG. 3 provides two coordinated power outputs from a power supply that support a same hotwire welding process.

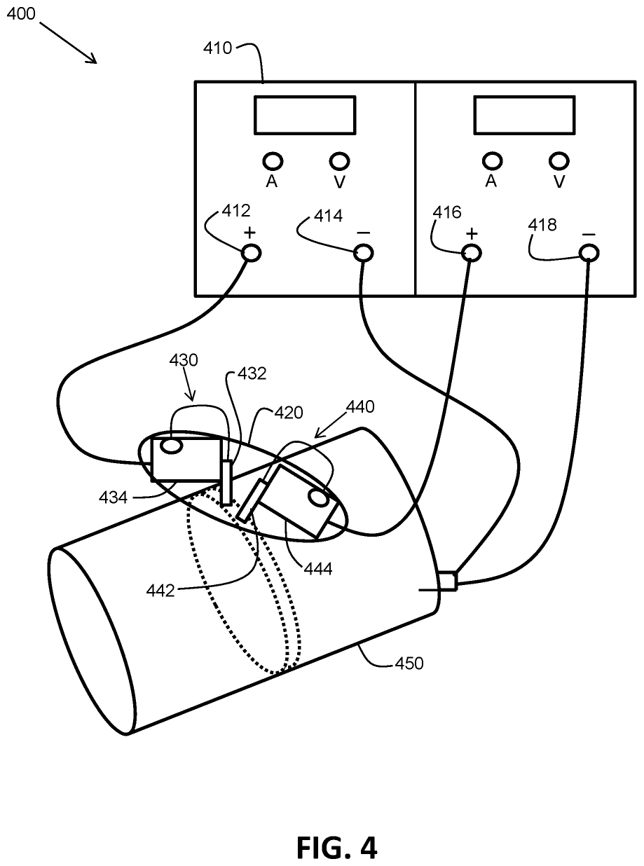

FIG. 4 illustrates a schematic diagram of one embodiment of a tandem metal inert gas (MIG) welding system 400 including a power supply 410 (e.g., similar to the power supply 130 of FIG. 1) configured to provide two power outputs that are coordinated with each other to support a same tandem metal inert gas (MIG) welding process. The power supply 410 includes at least one controller as in FIG. 1 (e.g., the controllers 150 and 160). The tandem MIG system 400 may also include an engine 110 and a generator 120 as in FIG. 1, in accordance with one embodiment, where the power supply 410 is configured to receive electrical input power from the generator. Alternatively, the power supply 410 may be configured to receive electrical input power from the local electrical power grid.

The power supply 410 is configured to convert the electrical input power (whether from a generator or a local electrical power grid) to form two power outputs that are coordinated with each other (e.g., coordinated in time, phase, frequency, and/or amplitude) via at least one controller to support a same tandem MIG welding process. The first power output of the two power outputs is a first MIG welding output and the second power output of the two power outputs is a second MIG welding output.

The tandem MIG welding system 400 also includes an orbital welding bug 420 including a first metal deposition welding device 430 and a second metal deposition welding device 440. The first metal deposition welding device 430 is powered by the first MIG welding output and the second metal deposition welding device 440 is powered by the second MIG welding output. The orbital welding bug 420 is configured to orbit around a joint between two sections of a workpiece 450 (e.g., two pipe sections) to be welded together.

In accordance with one embodiment, the power supply 410 is configured to pulse the first MIG welding output to create a first pulsing arc via the first metal deposition welding device 430. The power supply 410 is also configured to pulse the second MIG welding output to create a second pulsing arc via the second metal deposition welding device 440. The power supply 410 is configured to synchronize the first pulsing arc and the second pulsing arc in time. The time synchronization may be in phase, in accordance with one embodiment, or out of phase, in accordance with another embodiment.

As shown in FIG. 4, a first output terminal 412 of the power supply 410 is associated with the first power output, has a first polarity (e.g., a positive [+] polarity), and is electrically connected to the first metal deposition welding device 430 during the same tandem MIG welding process. A second output terminal 414 of the power supply 410 is associated with the first power output, has a second polarity (e.g., a negative [−] polarity), and is electrically connected to the workpiece 450 during the same tandem MIG welding process. A third output terminal 416 of the power supply 410 is associated with the second power output, has the first polarity (e.g., a positive [+] polarity), and is electrically connected to the second metal deposition welding device 440 during the same tandem MIG welding process. A fourth output terminal 418 of the power supply 410 is associated with the second power output, has the second polarity (e.g., a negative [−] polarity), and is electrically connected to the workpiece 450 during the same tandem MIG welding process. The electrical connections are facilitated by various electrical cables and clamps, as shown in FIG. 4.

The first metal deposition device 430 includes a first welding head 432 and a first wire electrode delivery mechanism 434 (e.g. a type of wire feeding device). The second metal deposition welding device 440 includes a second welding head 442 and a second wire electrode delivery mechanism 444 (e.g., a type of wire feeding device). The welding heads 432 and 442 may be a type of MIG welding torch configured specifically for operation with the orbital welding bug 420, in accordance with one embodiment. Again, the disclosure of U.S. Pat. No. 9,114,483, issued on Aug. 25, 2015, is incorporated herein by reference in its entirety, and is concerned with wire feeding technology.

In accordance with one embodiment, the power supply 410 includes a first controller (e.g., the controller 150 shown in FIG. 1) that is configured to control the first power output (i.e., the first MIG welding output) and a second controller (e.g., the controller 160 shown in FIG. 1) that is configured to control the second power output (i.e., the second MIG welding output). The first controller is configured to communicate with the second controller to communicate coordinating information about, for example, pulsing the two power outputs in a coordinated manner during a same tandem MIG welding process.

For example, the first controller is configured to communicate with the second controller to communicate information about pulsing the two power outputs (either in phase or out of phase) and about controlling gas flow and wire feed speed. For example, rates of shielding gas may be controlled in a coordinated manner for the two power outputs to the two metal deposition welding devices during a same tandem MIG welding process. Also, wire feed speeds may be controlled in a coordinated manner for the two wire electrode delivery mechanisms of the two metal deposition welding devices during a same tandem MIG welding process.

In one embodiment, the second controller is configured to receive communications from the first controller and adjust the second power output in response to the received communications during a same tandem MIG welding process. For example, the second controller is configured to receive communications from the first controller indicating that the first controller is commanding pulsing of the first power output. The second controller is configured to command pulsing of the second power output in coordination (e.g., in phase or out of phase) with the pulsing of the first power output in response to the communications. As another example, the second controller is configured to receive communications from the first controller indicating that the first controller is commanding pulsing of a first wire feed speed of the first wire electrode delivery mechanism. The second controller is configured to command pulsing of a second wire feed speed of the second wire electrode delivery mechanism in coordination (e.g., in phase or out of phase) with the pulsing of the first wire feed speed in response to the communications.

In this manner, the tandem MIG welding system 400 of FIG. 4 provides two coordinated power outputs from a power supply that support a same tandem MIG welding process.

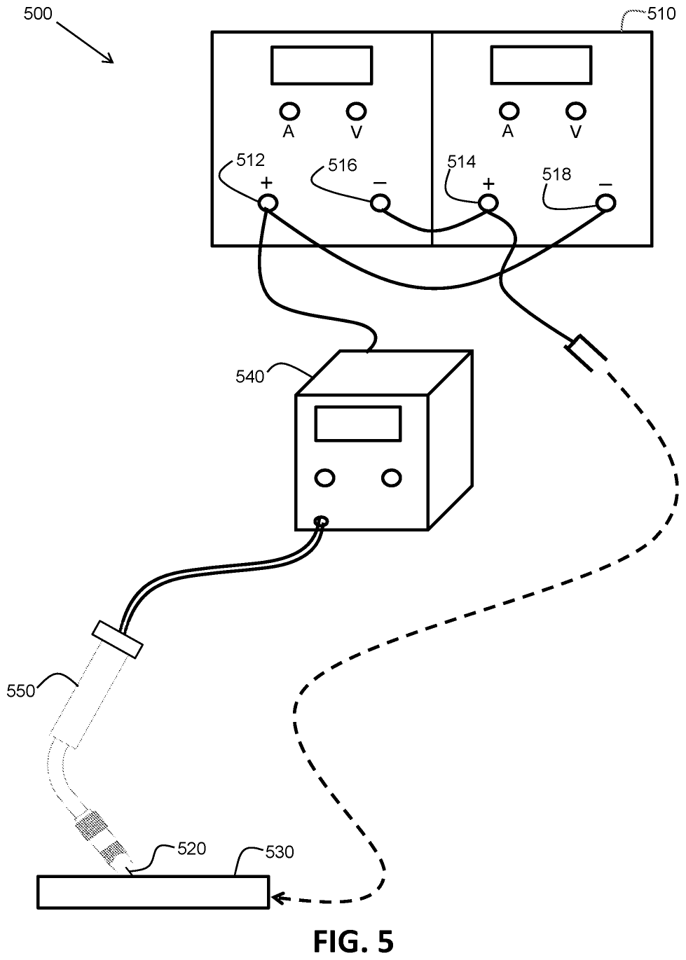

FIG. 5 illustrates a schematic diagram of one embodiment of an alternating current (AC) output system 500 including a power supply 510 (e.g., similar to the power supply 130 of FIG. 1) configured to provide two power outputs that are coordinated with each other to support a same AC welding process. The power supply 510 includes at least one controller as in FIG. 1 (e.g., the controllers 150 and 160). The AC output system 500 may also include an engine 110 and a generator 120 as in FIG. 1, in accordance with one embodiment, where the power supply 510 is configured to receive electrical input power from the generator. Alternatively, the power supply 510 may be configured to receive electrical input power from the local electrical power grid.

The power supply 510 is configured to convert the electrical input power (whether from a generator or a local electrical power grid) to form two power outputs that are coordinated with each other (e.g., coordinated in time, phase, frequency, and/or amplitude) via at least one controller to support a same AC output process. The first power output of the two power outputs provides a positive current portion and the second power output of the two power outputs provides a negative current portion. Referring to FIG. 5, in one embodiment, the positive current portion and the negative current portion, as coordinated, provide an alternating current (AC) welding waveform for creating a welding arc between a welding wire electrode 520 and a workpiece 530. AC welding waveforms are well known in the art and are not discussed in detail herein. In FIG. 5, the system 500 includes a wire feeding device 540 operatively connected to the power supply 510 and configured to feed the welding wire electrode 520 to a welding gun 550 to produce the welding arc between an end of the welding wire electrode 520 and the workpiece 530.

As shown in FIG. 5, a first output terminal 512 of the power supply 510 is associated with the first power output, has a first polarity (e.g., a positive [+] polarity), and is electrically connected to the welding wire electrode 520 via the wire feeding device 540 and the welding gun 550 during the same AC welding process. A second output terminal 514 of the power supply 510 is associated with the second power output, has the first polarity (e.g., a positive [+] polarity), and is electrically connected to the workpiece 530 during the same AC welding process. A third output terminal 516 of the power supply 510 is associated with the first power output, has a second polarity (e.g., a negative [−] polarity), and is electrically connected to the second output terminal 514 during the same AC welding process. A fourth output terminal 518 of the power supply 510 is associated with the second power output, has the second polarity (e.g., a negative [−] polarity), and is electrically connected to the first output terminal 512 during the same AC welding process. The electrical connections are facilitated by various electrical cables and clamps, as shown in FIG. 5.

In accordance with one embodiment, the power supply 510 includes a first controller (e.g., the controller 150 shown in FIG. 1) that is configured to control the first power output (providing the positive current portion) and a second controller (e.g., the controller 160 shown in FIG. 1) that is configured to control the second power output (providing the negative current portion). The first controller is configured to communicate with the second controller to communicate coordinating information about, for example, the timing and phasing of the positive current portion with respect to the negative current portion during a same AC welding process. Also, characteristics of the positive current portion (e.g., frequency, amplitude, wave shape) may affect characteristics of the negative current portion in a coordinated manner as the first controller communicates characteristic information to the second controller during the same AC welding process.

In this manner, the alternating current (AC) output system 500 of FIG. 5 provides two coordinated power outputs from a power supply that support a same AC welding process.

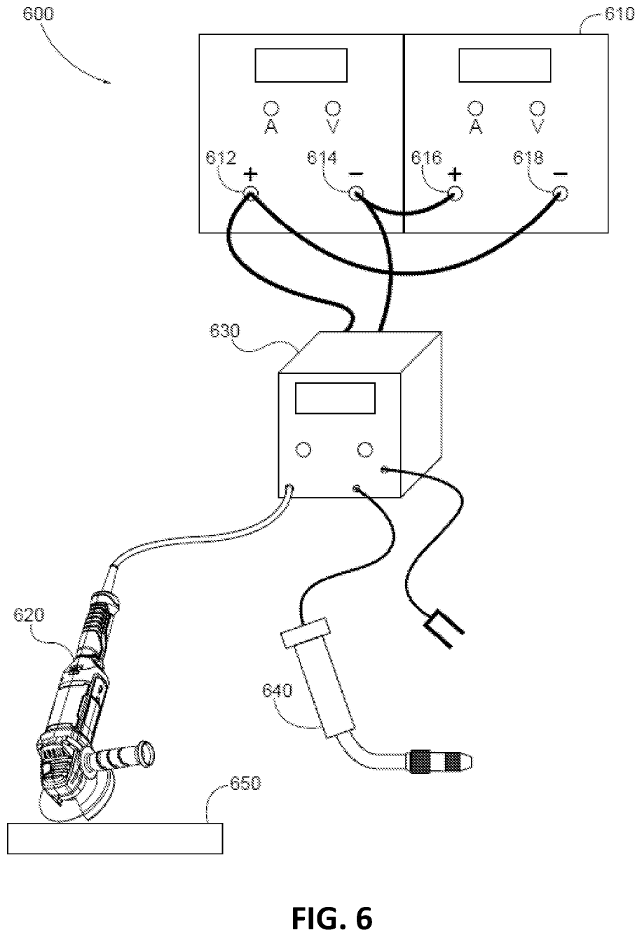

FIG. 6 illustrates a schematic diagram of one embodiment of an alternating current (AC) output system 600 including a power supply 610 (e.g., similar to the power supply 130 of FIG. 1) configured to provide two power outputs that are coordinated with each other to support a same AC welding process. The power supply 610 includes at least one controller as in FIG. 1 (e.g., the controllers 150 and 160). The AC output system 600 may also include an engine 110 and a generator 120 as in FIG. 1, in accordance with one embodiment, where the power supply 610 is configured to receive electrical input power from the generator. Alternatively, the power supply 610 may be configured to receive electrical input power from the local electrical power grid.

The power supply 610 is configured to convert the electrical input power (whether from a generator or a local electrical power grid) to form two power outputs that are coordinated with each other (e.g., coordinated in time, phase, frequency, and/or amplitude) via at least one controller to support a same AC output process. The first power output of the two power outputs provides a positive current portion and the second power output of the two power outputs provides a negative current portion. Referring to FIG. 6, in one embodiment, the positive current portion and the negative current portion, as coordinated, provide a sinusoidal alternating current (e.g., at 50 Hz or 60 Hz) for powering an auxiliary tool 620 (e.g., a grinder, lights, a drill, a saw, a cutter). Sinusoidal alternating currents for powering auxiliary tools are well known in the art and are not discussed in detail herein. In FIG. 6, the system 600 includes a wire feeding device 630 operatively connected to the power supply 610 and configured to feed a welding wire electrode to a welding gun 640 to produce a welding arc between an end of the welding wire electrode and a workpiece 650 during a welding process (e.g., similar to FIG. 5). However, the wire feeding device 630 is also configured to have the auxiliary tool 620 operatively connected thereto. That is, the sinusoidal alternating current is provided to the auxiliary tool 620 from the power supply 610 via the wire feeding device 630. In accordance with an alternate embodiment, the auxiliary tool 620 may be operatively connected directly to the power supply 610.

As shown in FIG. 6, a first output terminal 612 of the power supply 610 is associated with the first power output, has a first polarity (e.g., a positive [+] polarity), and is electrically connected to the auxiliary tool 620 via the wire feeding device 630 during a same AC welding process. A second output terminal 614 of the power supply 610 is associated with the first power output, has a second polarity (e.g., a negative [−] polarity), and is electrically connected to the auxiliary tool 620 via the wire feeding device 630 during a same AC welding process. A third output terminal 616 of the power supply 610 is associated with the second power output, has the first polarity (e.g., a positive [+] polarity), and is electrically connected to the second output terminal 614 during the same AC welding process. A fourth output terminal 618 of the power supply 610 is associated with the second power output, has the second polarity (e.g., a negative [—] polarity), and is electrically connected to the first output terminal 612 during the same AC welding process. The electrical connections are facilitated by various electrical cables and clamps, as shown in FIG. 6.

In accordance with one embodiment, the power supply 610 includes a first controller (e.g., the controller 150 shown in FIG. 1) that is configured to control the first power output (i.e., the positive current portion) and a second controller (e.g., the controller 160 shown in FIG. 1) that is configured to control the second power output (i.e., the negative current portion). The first controller is configured to communicate with the second controller to communicate coordinating information about, for example, the timing and phasing of the positive current portion with respect to the negative current portion during a same AC welding process. Also, characteristics of the positive current portion (e.g., frequency, amplitude, sinusoidal wave shape) may affect characteristics of the negative current portion in a coordinated manner as the first controller communicates characteristic information to the second controller during the same AC welding process.

In this manner, the alternating current (AC) output system 600 of FIG. 6 provides two coordinated power outputs from a power supply that support a same AC welding process.

FIG. 7 illustrates one embodiment of an example controller 700 (e.g., the controller 150 and/or the controller 160 used in the power supply 130 of the system 100 of FIG. 1). The controller 700 includes at least one processor 714 (e.g., a microprocessor) which communicates with a number of peripheral devices via bus subsystem 712. These peripheral devices may include a storage subsystem 724, including, for example, a memory subsystem 728 and a file storage subsystem 726, user interface input devices 722, user interface output devices 720, and a network interface subsystem 716. The input and output devices allow user interaction with the controller 700. Interface subsystem 716 provides an interface to outside devices and networks and is coupled to corresponding interface devices in other computer or electronic systems such as, for example, conventional computers, digital signal processors, and/or other computing devices. For example, in one embodiment, interface subsystem 716 supports interfacing of the controller 160 to a wire feeding device 320.

User interface input devices 722 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into the controller 700 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from the controller 700 to the user or to another machine or computer system.

Storage subsystem 724 stores programming and data constructs that provide or support some or all of the functionality described herein (e.g., as software modules). For example, the storage subsystem 724 may include various programmable welding mode constructs for controlling the power electronics 310 and the wire feeding device 320.

Software modules are generally executed by processor 714 alone or in combination with other processors. Memory 728 used in the storage subsystem can include a number of memories including a main random access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain embodiments may be stored by file storage subsystem 726 in the storage subsystem 724, or in other machines accessible by the processor(s) 714.

Bus subsystem 712 provides a mechanism for letting the various components and subsystems of the controller 700 communicate with each other as intended. Although bus subsystem 712 is shown schematically as a single bus, alternative embodiments of the bus subsystem may use multiple buses.

The controller 700 can be configured as any of various types including a microprocessor and other components on a printed circuit board (PCB), a workstation, a server, a computing cluster, a blade server, a server farm, or any other data processing system or computing device. Due to the ever-changing nature of computing devices and networks, the description of the controller 700 depicted in FIG. 7 is intended only as a specific example for purposes of illustrating some embodiments. Many other configurations of the controller 700 are possible having more or fewer components than the controller depicted in FIG. 7.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or illustrative examples shown and described. Thus, this disclosure is intended to embrace alterations, modifications, and variations that fall within the scope of the appended claims, which satisfy the statutory subject matter requirements of 35 U.S.C. § 101. The above description of specific embodiments has been given by way of example. From the disclosure given, those skilled in the art will not only understand the general inventive concepts and attendant advantages, but will also find apparent various changes and modifications to the structures and methods disclosed. It is sought, therefore, to cover all such changes and modifications as fall within the spirit and scope of the general inventive concepts, as defined by the appended claims, and equivalents thereof.

What is claimed is:

1. An alternating current (AC) output system, the alternating current (AC) output system comprising:
an engine;
a generator operatively connected to the engine, wherein the engine is configured to drive the generator to produce electrical input power; and
a power supply operatively connected to the generator and having at least one controller, wherein the power supply is configured to convert the electrical input power to form two power outputs that are coordinated with each other, at least in time, via the at least one controller to support a same alternating current (AC) output process,
wherein a first power output of the two power outputs provides a positive current portion and a second power output of the two power outputs provides a negative current portion, and wherein the positive current portion and the negative current portion, as coordinated, provide an alternating current (AC) welding waveform for creating a welding arc between a welding electrode and a workpiece.

2. The alternating current (AC) output system of claim 1, further comprising:
a first output terminal of the power supply, associated with the first power output and having a first polarity, to be electrically connected to the welding electrode during the same alternating current (AC) output process;
a second output terminal of the power supply, associated with the second power output and having the first polarity, to be electrically connected to the workpiece during the same alternating current (AC) output process;
a third output terminal of the power supply, associated with the first power output and having a second polarity, to be electrically connected to the second output terminal during the same alternating current (AC) output process; and
a fourth output terminal of the power supply, associated with the second power output and having the second polarity, to be electrically connected to the first output terminal during the same alternating current (AC) output process.

3. The alternating current (AC) output system of claim 1, further comprising a wire feeding device operatively connected to the power supply.

4. The alternating current (AC) output system of claim 1, wherein the at least one controller includes a first controller configured to control the first power output and a second controller configured to control the second power output, and wherein the first controller is configured to communicate with the second controller to communicate coordinating information.

5. The alternating current (AC) output system of claim 1, wherein the two power outputs are further coordinated with each other in at least one of frequency and amplitude via the at least one controller to support the same alternating current (AC) output process.

6. The alternating current (AC) output system of claim 1, wherein the at least one controller is configured such that a frequency, an amplitude, and a wave shape of each of the positive current portion and the negative current portion are coordinated with each other.

7. The alternating current (AC) output system of claim 1, wherein the at least one controller is configured to control a timing and a phasing of the positive current portion with respect to the negative current portion during the same AC welding process.

8. The alternating current (AC) output system of claim 1, wherein the positive current portion and the negative current portion of the same alternating current (AC) output process provide one of a tungsten inert gas (TIG) welding output, a metal inert gas (MIG) welding output, a submerged arc welding (SAW) output, or a flux cored arc welding (FCAW) output.

9. The alternating current (AC) output system of claim 1, wherein the power supply is further configured to receive the electrical input power from a local electrical power grid as an alternative to using the generator to produce the electrical input power.

10. An alternating current (AC) output system, the alternating current (AC) output system comprising:
an engine;
a generator operatively connected to the engine, wherein the engine is configured to drive the generator to produce electrical input power;
a power supply operatively connected to the generator and having at least one controller, wherein the power supply is configured to convert the electrical input power to form two power outputs that are coordinated with each other, at least in time, via the at least one controller to support a same alternating current (AC) output process; and
an auxiliary tool configured to be electrically connected to the power supply,
wherein a first power output of the two power outputs provides a positive current portion and a second power output of the two power outputs provides a negative current portion, wherein the positive current portion and the negative current portion, as coordinated, provide a sinusoidal alternating current for powering the auxiliary tool.

11. The alternating current (AC) output system of claim 10, further comprising:
a first output terminal of the power supply, associated with the first power output and having a first polarity, to be electrically connected to the auxiliary tool during the same alternating current (AC) output process;
a second output terminal of the power supply, associated with the first power output and having a second polarity, to be electrically connected to the auxiliary tool during the same alternating current (AC) output process;
a third output terminal of the power supply, associated with the second power output and having the first polarity, to be electrically connected to the second output terminal during the same alternating current (AC) output process; and
a fourth output terminal of the power supply, associated with the second power output and having the second polarity, to be electrically connected to the first output terminal during the same alternating current (AC) output process.

12. The alternating current (AC) output system of claim 10, wherein the auxiliary tool is operatively connected directly to the power supply.

13. The alternating current (AC) output system of claim 10, further comprising a wire feeding device operatively connected between the power supply and the auxiliary tool.

14. The alternating current (AC) output system of claim 10, wherein the at least one controller includes a first controller configured to control the first power output and a second controller configured to control the second power output, and wherein the first controller is configured to communicate with the second controller to communicate coordinating information.

15. The alternating current (AC) output system of claim 10, wherein the two power outputs are further coordinated with each other in at least one of frequency and amplitude via the at least one controller to support the same alternating current (AC) output process.

16. The alternating current (AC) output system of claim 10, wherein the two power outputs are further coordinated with each other in phase, frequency, and amplitude.

17. The alternating current (AC) output system of claim 10, wherein the power supply is further configured to receive the electrical input power from a local electrical power grid as an alternative to using the generator to produce the electrical input power.

18. The alternating current (AC) output system of claim 10, wherein the sinusoidal alternating current is at one of 50 Hz or 60 Hz.

19. The alternating current (AC) output system of claim 10, wherein the auxiliary tool is at least one of a grinder, electrical lights, a drill, a saw, and a cutter.

20. The alternating current (AC) output system of claim 10, further comprising a welding gun configured to be electrically connected to and operate with the power supply, even when the auxiliary tool is connected to the power supply.
